(19) United States
(12) Patent Application Publication
(10) Pub. No.: US 2018/0184670 A1
(43) Pub. Date: Jul. 5, 2018

(54) Machine For Manufacturing Flatbread

(71) Applicant: Yilma Asfaw, Bellaire, TX (US)

(72) Inventor: Yilma Asfaw, Bellaire, TX (US)

(21) Appl. No.: 15/613,215

(22) Filed: Jun. 4, 2017

Related U.S. Application Data
(60) Provisional application No. 62/345,612, filed on Jun. 3, 2016.

(51) Int. Cl. A21B 7/00; A21C 5/00

(52) U.S. Cl. CPC A21B 7/005; A21C 5/006

(57) ABSTRACT

A machine for manufacturing of flatbread mainly Ethiopian Injera, sometimes known as Enjera. The machine comprises five sections namely batter reservoir, batter depositor, baking section, picking section and baking surface cleaning section. The batter reservoir comprises a tank with a blender to slowly blend the batter to attain uniform viscosity and a mesh to filter out any coagulated materials in the batter. The batter depositor section has an integrated batter deposition apparatus that deposits batter to a uniform thickness on a hot non-sticky baking surface. The baking section comprises of mechanism to close lids of baking pans to bake bread to a desirable temperature. Picking section is where flatbread picked from the baking surface to be cooled to a room temperature and pack for distribution. Finally, the cleaning section is where baking surfaces cleaned and get ready to start another baking cycle.

### TECHNICAL FIELD

The invention relates to an automated manufacturing machine for the manufacturing of mainly Injera also known as Enjera. The same machine can be used to manufacture flatbread such as crepe, Chinese, and Indian flatbread.

### BACKGROUND OF THE INVENTION

Injera is a circular, thin bread widely known in Ethiopia and some neighboring countries. Sometimes it may be called Enjera. It is a spongy, vesicular textured, sour test flatbread. It is usually made of Teff flour in Ethiopia. Teff is the smallest gain grown mainly in Ethiopia. Nowadays, Ethiopian community in developed countries started adding wheat/self-rising, barley flours in Teff batter.

For centuries most Ethiopians bake Injera on a hot hand-made clay pan using wood as a source of heat. Some people use hand-made clay pan using electric heaters. Some Ethiopian diaspora start using metal cooking pan coated with non-sticky coat to bake Injera, in both the above cases one Injera is baked at a time. A few people mainly in the North America patented automated machines to manufacture Injera: U.S. Pat. No. 7,421,943 (Yoseph) describes injera baking machine, U.S. Pat. No. 7,063,008 and a Canadian Pat. No. CA 2415621 (Wundeb) describes Injera manufacturing system, and U.S. Pat. Application Publication No. 2005/0208183 (Emru) describes method of and apparatus for making Ethiopian bread, U.S. Pat. Application Publication No. 2003/0143309 (Mengistu Kindie et. al) describes Method and Apparatus for Making Bread, U.S. Pat. Application Publication No. 2011/0189361A1 (Wassie Mulugeta) describes a Rotary Baking System and Method, U.S. Pat. Application Publication No. 2012/0247344 A1 (Michael Ma) describes Method and Apparatus for Rapid Production of Injera Bread.

Most of patented designs so far are not easily customizable to small and large flatbread manufacturing businesses. Besides that only a handful of automated machines are constructed in North America to solve Injera baking challenges that many Ethiopian and East African community faced. People are still baking Injera in one at a time fashion. The process is very time consuming and less safer from hygienic point of view as Injera baking process involves much hand using from the beginning to the end.

It is a general objective of this invention to provide an improved, fully automated machine for manufacturing of flatbread mainly Injera with a relatively small size, less costly and less human interference. The machine is capable of producing multiple Injera pieces continuously. The design of the machine is easily customizable to fit small to very large quantities Injera manufacturing. The machine can easily be disassembled for easier transportation.

### BRIEF DESCRIPTION OF THE DRAWINGS

This invention will be better understood from the following detailed description taken in conjunction with the accompanying drawings, wherein:

FIG. 1 is a top schematic view of the present invention showing five sections of the machine

FIG. 2 is a perspective schematic view of the present invention with detailed FIG. 3 and FIG. 4

FIG. 3 is a detailed schematic view of the batter reservoir tank, detailed from FIG. 2

FIG. 4 is a detailed schematic view of the batter deposition unit, detailed from FIG. 2

FIG. 5 is a perspective schematic view of Injera batter depositor

FIG. 6 is a perspective schematic view of the batter depositor showing deposition of batter on baking surface with detailed FIG. 7

FIG. 7 is a perspective schematic view of the batter depositor showing deposition of batter, detailed from FIG. 6

FIG. 8 is a detailed schematic view of the batter depositor showing the batter flow control gate in closed position, detailed from FIG. 7

FIG. 9 is a detailed schematic view of the batter depositor showing the batter flow control gate in open position, detailed from FIG. 7

FIG. 10 is side schematic view of the present invention

FIG. 11 is a schematic view showing lid closing mechanism, detailed from FIG. 10

FIG. 12 is side schematic view showing lid opening mechanism, detailed from FIG. 10

FIG. 13 a side schematic view showing flow control as batter exit from the reservoir tank, detailed from FIG. 10

### DETAILED DESCRIPTION OF INVENTION

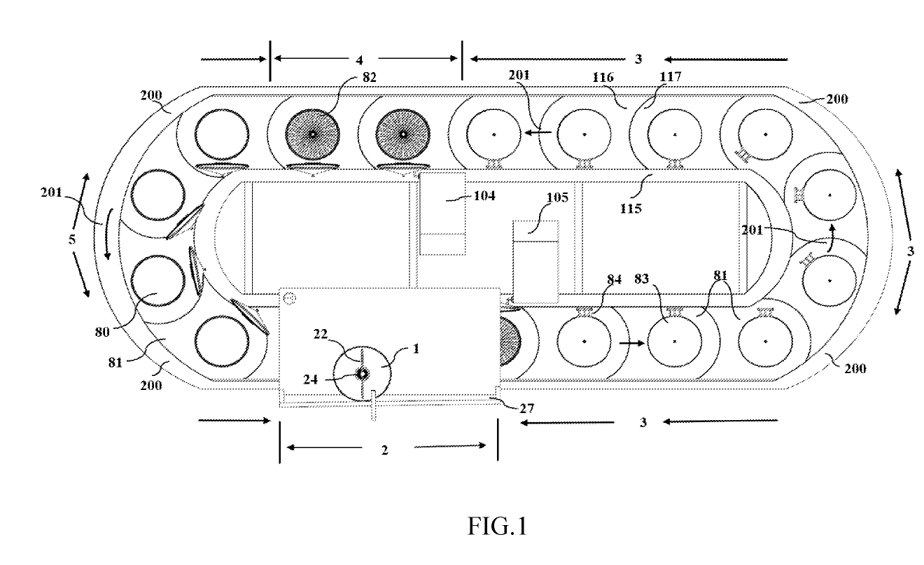

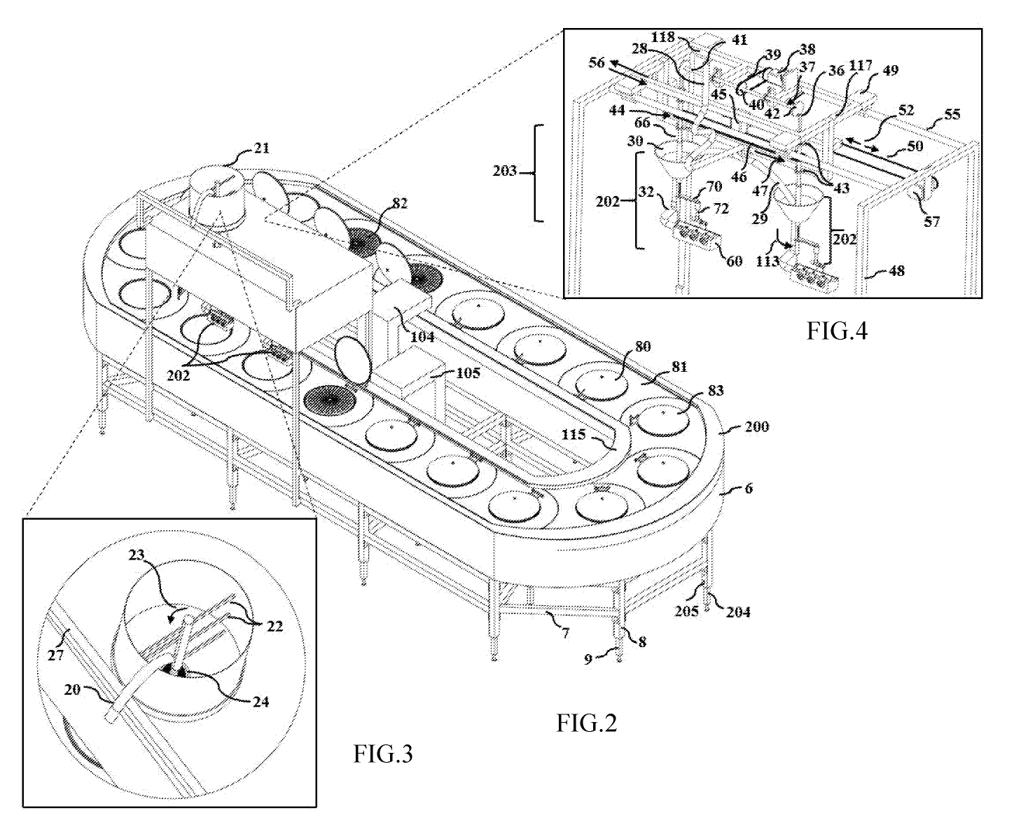

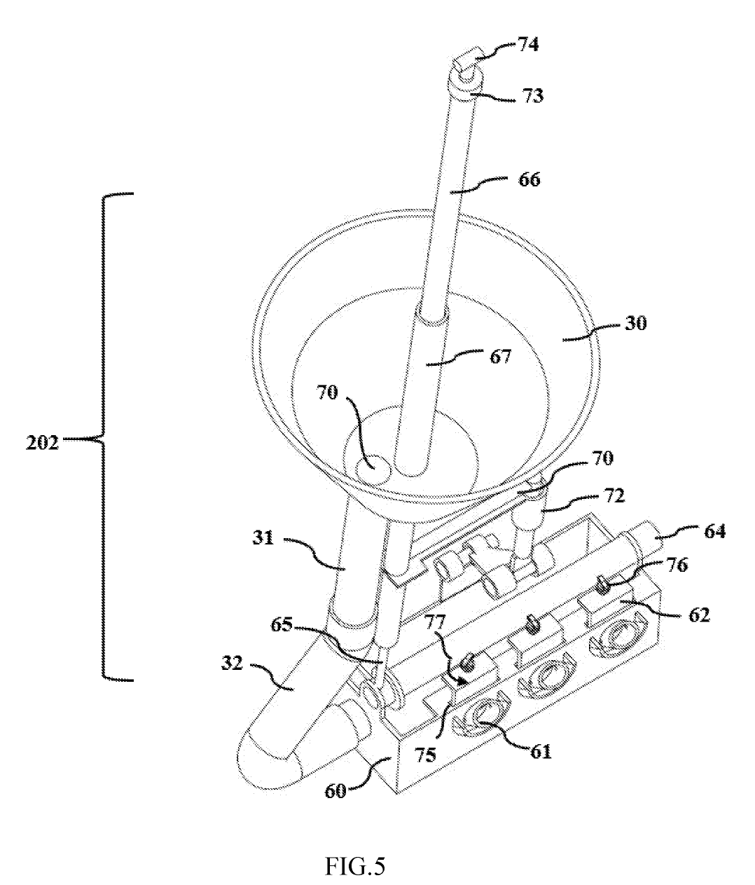

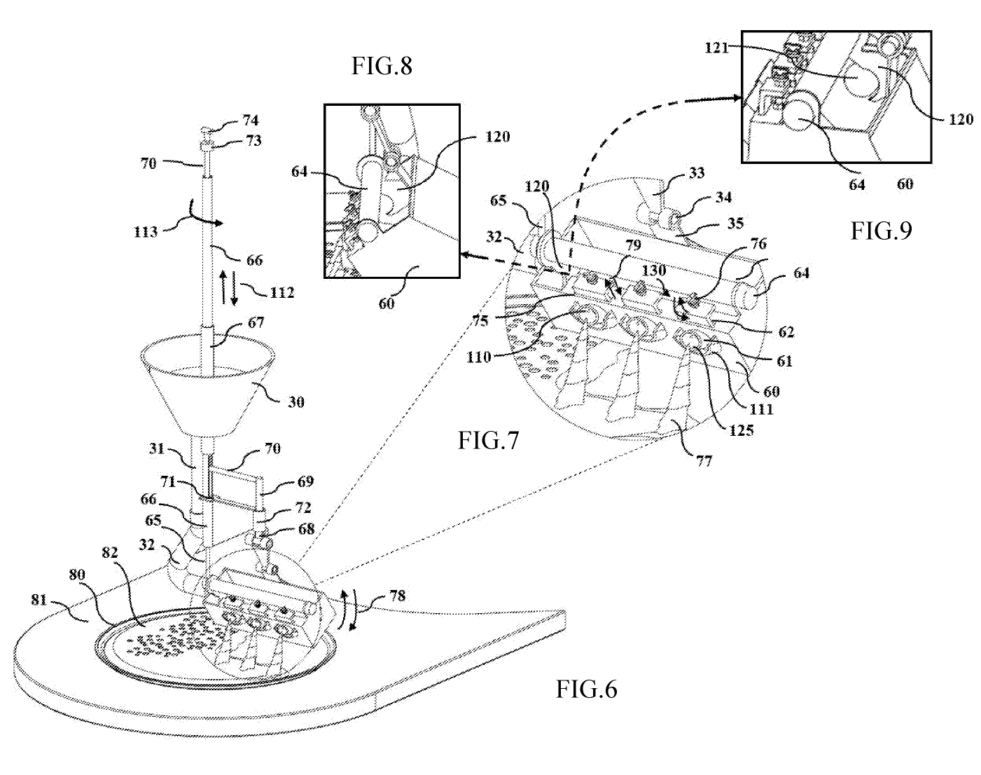

FIG. 1 shows five sections of the machine for mass manufacturing of Injera and different components of the present invention. The five sections are batter reservoir tank 1, batter deposition 2, baking 3, picking 4 and pan surface cleaning 5. FIG. 1 show batter reservoir 1 with a blending mechanical arm 22 to make a uniform viscosity batter that could form layers by gravitationally segregation if left non stirred and a mesh 24 to filter out any coagulated materials in the batter that might be created during flours mixing. The reservoir tank 21 is mounted on a support frame 27 which is attached to the main machine body 6, 7 (FIG. 2); Injera batter depositor section 2 has integrated Injera batter deposition apparatus (FIG. 4, FIG. 5, FIG. 6); baking section 3 comprises pans 80 with pan carrier 81 and lids 83 with heat source underneath the non-sticky baking surface 80; baking section 3 is where Injera bake to a desired temperature and texture. The machine has outer rail 200 and inner rail 115, the rails 200,115 have rotated U-shape facing towards the pan carriers 81. The pan carriers 81 is sandwiched between the upper and lower frames of the U-shape, for smooth movement 201 of pan carriers, roller bearing or other kind of bearing may be used underneath the carriers 81. Straight toothed sprocket might be attached on the bottom or side of the pan carrier 81 to create rotational movement of the pan carriers 81. The pan carriers 81 have curved shape in both front and tail of the carriers 81 that allows easier direction changes as carrier 81 moves especially on either end of the machine. The front end 117 of the pan carrier 81 pushes the tail 116 end of the pan carrier 81 in the front.

FIG. 2 is a perspective schematic view showing details of the present invention. FIG. 2 shows reservoir tank 21, batter depositor 202, machine bottom support frames 6,7,8,9. The machine legs may have holes 205 with pins for height adjustment 204.

FIG. 3 shows mechanical arms 22 which rotates 23 slowly and continuously to blend the batter mix that comes in to the tank 21 through pipe 20. The conveyor/pan carriers 81 shall rotate 201 continuously. Once batter deposition on baking surface 80 completed, motor 57 rotates 52 in an opposite direction to move the batter dispensing unit 202 back to the original position then another deposition cycle starts.

FIG. 4 show detailed of the batter deposition unit 203. The unit 203 has two batter depositors 202 which move 52 back and forth; rotates 113 (FIG. 6) together when batter deposition commences. The two depositors 202 are connected to rotary frame 66 which is connected to the stationary machine body 36, motor 38 with belt 39 and pulley 40 system may control 37 the upward 112 (FIG. 6) and downward 112 movement of the depositor tank 60. Bar 41 connects pulley 42 and pulley 40 that drives by the belt 39 and motor 37. Frame 41 and motor 38 connected to horizontal frames 117,118 that has four linear bearings 49 for easier sliding of the deposition units 202 on frame 55 when moving back 52 and forth 52 to deposit batter. Motor 57 with belt 50 system controls the back 52,56 and forth 52,56 movement of the depositors 202; motor 45 with belt 46, pulley 44 system controls the rotation 47 of deposition units 202; motor 38 controls 112 the rotation 78 of the deposition tank 60 (FIG. 6). Batter deposition unit 202 follow the pan movement 201 to deposit batter in the baking surfaces 80, the unit 202 return back quickly to the original position for another deposition cycle. Even though a 3 axis CNC type control mechanism is used in the present invention, other mechanisms such as linear motors, pneumatics, hydraulics etc may be used during manufacturing of the machine.

For better understanding of the invention an integrated descriptions of FIG. 5, FIG. 6, FIG. 7, FIG. 8 and FIG. 9 is better. The figures show detailed of batter deposition unit 202. The unit 202 has stationary pipes 28, 29 (FIG. 4) that transport batter to the rotary tanks 30 which have holes 70; the hole 70 is connected to pipe 31, 32 that transport batter to the depositor tank 60. The tank 30 has a central pipe 67 for easier connection to vertical support 67,66,73,74 and for easier cleaning. Stationary bar 74 may be connected to stationary pipe 66 with joint 73, a thrust bearing type rotary joint 73 may be used. The main support pipe 66 has opening to pass smaller pipe 70 inside, the rotation of motor 38 (FIG. 1) moves the pipe 70 up 112 which in turn moves all the connected pipes and bars 69,68, 33,34,35 up 112. Since bar 35 is connected to depositor tank 60, the tank moves up 78 to pour 77 batter 82 on the baking surface 80. The tank 60 rotates 78 on bar 64 which is connected to bar 65, 66. Both bars 66, 65, 64 does not move up and down 112 since connected to the machine body by insert bearing 43 (FIG. 4). The flow 77 of batter coming out of the tank 60 is controlled by gates 62, which has L shape, the gates 62 slides through slots 75 on the tank surface 60. A screw 76 type movement 130 may be used to move the gate 62 up or down 79 to control the opening in the pipe 61 that in turn control the amount of batter 82 pour 77 to the baking surface 80. Pipe 61 has outer pipe 111 to collect batter drop from the pipe 61 when reservoir tank 60 moves back 78 to original position, none spreading position. Opening 110 on all pipes 61 allows movement of batter from the collector pipe 111 to the tank 60. The hole 110 is higher than the tip 125 of the pipe 61 so batter may not pour from the tank 60 to the collector pipe 111. Baking pan 80 is mounted on pan carrier 81. FIG. 8 and FIG. 9 shows details of flow control gate 120 to the tank 60. The gate 120 has a crescent shape which is stationary and as tank moves down 78 the gate opens and allows movement of batter in to the tank 60, whereas when the tank 60 moves up 78, the opening 121 closes by the gate 120 to stop the flow of batter in to the tank 60 for better flow amount control. Low viscosity of Injera batter 77 and surface tension spreads the deposited batter to fill baking pan 80.

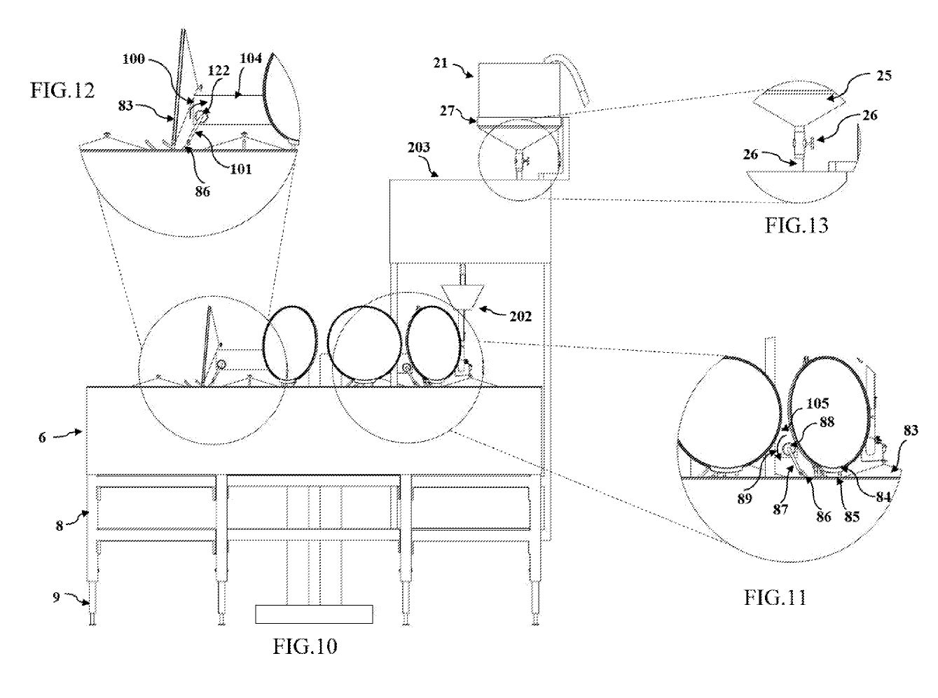

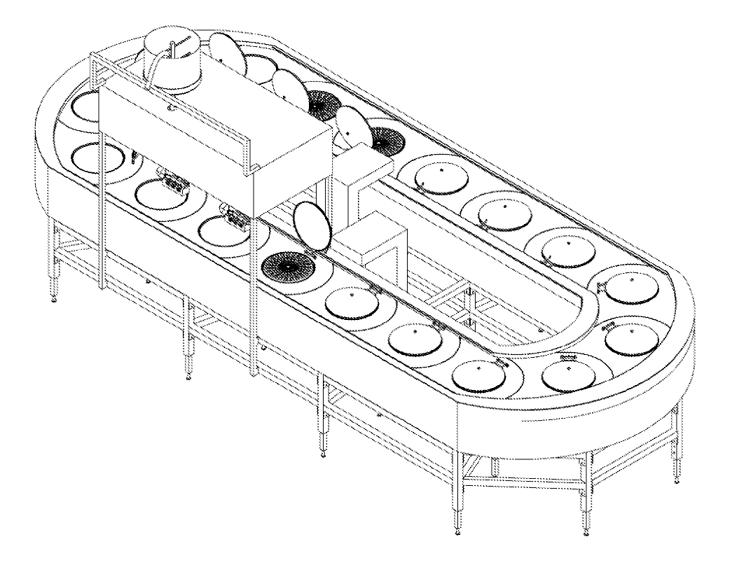

FIG. 10 shows the mechanical lid opening and closing mechanisms. The lid 83 has U shaped frame 84 that is connected to frame 85 on the pan carrier 81. The angular bar 86 is connected to bar 84. FIG. 11 shows lid 83 closing mechanism, a motor 88 with rotary mechanical arm 87 mounted on frame 105, the arm 87 has L shape and the lower part of the L pushes 89 angular bar 86 mounted on the lid 83 to force the lid 83 to close. FIG. 12 shows lid 83 opening mechanism, a motor 122 with rotary mechanical arm 101 mounted on frame 104, the arm 101 has L shape and the lower part of the arm 101 pushes 89 the angular bar 86 mounted on the lid 83 to force the lid 83 to open. FIG. 13 shows a manual flow control valve to control the amount of batter going to a mini batter reservoir tanks 30. The reservoir tank 21 is attached to a pipe 26 for transport of batter to pipe 28, 29 (FIG. 4). A controlled metering pump may also be used instead of manual flow control 26 to meter the amount of Injera batter passing to Injera deposition apparatus 202.

Among different kind of non-sticky baking surface 80, PTFE coated non-sticky surface shall more probably be used in the present invention. PTFE can withstand a maximum temperature of up to 350 C and the Injera batter can bake well within half a minute at this temperature.

The connections, parts/components, methods mentioned in this invention are well known in the field of the invention and may easily be understandable by person skilled in the art of science, so details of connections, parts/components, methods are not discussed in very detail.

The invention shown from FIG. 1 to FIG. 13 and the above detailed description of the invention shown are the preferred method of Injera manufacturing. In this invention, modification, re-arranging, alteration of different parts in the Injera manufacturing apparatus may be made within the scope of the invention.

1. A machine for manufacturing of flatbread mainly Ethiopian circular, thin, flatbread comprising:
A batter reservoir tank with mesh and blending arm; crescent shaped baking pan carrier; Injera batter deposition unit; Injera batter deposition mechanism; a mechanism to control Injera thickness using gates; batter drop control mechanism; mechanical arms to open and close pan lids

2. A machine for manufacturing of flatbread as set forth in claim 1, wherein said the machine has five sections namely: batter reservoir, batter depositor, baking, picking and baking surface cleaning

3. A machine for manufacturing of flatbread as set forth in claim 1, wherein said a the reservoir tank has a mechanical arm to form a uniform viscosity batter

4. A machine for manufacturing of flatbread as set forth in claim 1, wherein said the reservoir tank has a mesh

5. A machine for manufacturing of flatbread as set forth in claim 1, wherein said Injera batter deposition unit and mechanism that depositors move with the conveyor to deposit Injera batter on to baking surface

6. A machine for manufacturing of flatbread as set forth in claim 5, wherein said the batter deposition apparatus has gates to control batter flow in turn Injera thickness and batter spreading

7. A machine for manufacturing of flatbread as set forth in claim 5, wherein said batter depositor unit contains gate to stop flow of batter to the tank when depositor deposits Injera batter

8. A machine for manufacturing of flatbread as set forth in claim 5, wherein said Injera batter deposition unit contains connection of pipes, bars and pulley to control Injera batter deposition

9. A machine for manufacturing of flatbread as set forth in claim 5, wherein said Injera batter deposition unit contains bucket and connection of pipes to allow a stationary pipe to pour Injera batter to rotating buckets for better batter transfer

10. A machine for manufacturing of flatbread as set forth in claim 5, wherein Injera batter deposition unit has collector to control batter drops

11. A machine for manufacturing of flatbread as set forth in claim 5, wherein Injera batter deposition unit has pipes with holes to allow movement of batter from collector pipe to the depositor bank

12. A machine for manufacturing of flatbread as set forth in claim 1, wherein said the invention has rotary mechanical arms to open and close pan lids

13. A machine for manufacturing of flatbread as set forth in claim 1, wherein said pan lids attached to pan carrier with hinge

14. A machine for manufacturing of flatbread as set forth in claim 1, wherein said pan lids has angular bar for better lid opening and closing

15. A machine for manufacturing of flatbread as set forth in claim 1, pan carrier pans have curved shape in the front and in the back for easier movement especially when carrier pans change movement direction at each end of the machine
